(19) United States
(12) Patent Application Publication
(10) Pub. No.: US 2013/0071132 A1
(43) Pub. Date: Mar. 21, 2013

(54) FUSER PROTECTION DEVICE AND IMAGE FORMING APPARATUS HAVING THE SAME

(71) Applicant: SAMSUNG Electronics Co. Ltd., Suwon-si (KR)

(72) Inventors: Dong Kyu KIM, Suwon-si (KR); Kwon Cheol LEE, Seoul (KR)

(73) Assignee: SAMSUNG Electronics Co., Ltd., Suwon-si (KR)

(21) Appl. No.: 13/623,286

(22) Filed: Sep. 20, 2012

(30) Foreign Application Priority Data
Sep. 20, 2011 (KR) 10-2011-0094666

(51) Int. Cl. G03G 15/20

(52) U.S. Cl. 399/33

(57) ABSTRACT

A fuser protection device realizing a protection circuit to protect a fuser by forcibly turning off a heater lamp when the heater lamp is overheated using a sensing signal from a non-contact thermistor to sense surface temperature of a heating roller and an image forming apparatus having the same. The fuser protection device includes a temperature sensing unit to sense a temperature of the heating roller in a non-contact fashion using two sensors provided at different positions, a differential amplifier to amplify a voltage difference between two sensor outputs from the temperature sensing unit, and a comparator to compare an output voltage from the differential amplifier with a reference voltage, wherein power supply to the heater lamp is blocked according to an output signal from the comparator.

### CROSS-REFERENCE TO RELATED APPLICATIONS

This application claims priority under 35 U.S.C. §119 from Korean Patent Application No. 2011-0094666, filed on Sep. 20, 2011 in the Korean Intellectual Property Office, the disclosure of which is incorporated herein by reference in its entirety.

### BACKGROUND OF THE INVENTION

1. Field of the Invention

Embodiments of the present general inventive concept relate to a fuser protection device to protect a fuser from overheating and an image forming apparatus having the same.

2. Description of the Related Art

Generally, an image forming apparatus, such as a copier, printer, facsimile or a multifunction device having functions of the copier, printer, and facsimile, prints an input image signal on printing media.

The image forming apparatus includes a supply unit to supply printing media, an image forming unit to form an image on the supplied printing media, a fuser to fuse the image to the printing media, and a discharge unit to discharge the printing media, to which the image is fused, from the image forming apparatus.

The fuser includes a heating roller and pressing roller. The heating roller and pressing roller fuse the image to the printing media using heat and pressure. The heating roller is heated by a heater lamp, which is a heat source mounted in the heating roller.

The image forming apparatus may use a first thermistor to detect temperature of the heating roller heated by the heater lamp and a second thermistor to protect the system when the first thermistor malfunctions. When an abnormal situation, in which temperature sensed by the second thermistor exceeds a predetermined temperature, occurs, the heater lamp may be forcibly turned off.

A non-contact thermistor may be usable to precisely detect a temperature and to respond to a temperature change. However, since costs for installing the non-contact thermistor are high, a contact thermistor is used as the thermistor since the second thermistor is not used to precisely detect temperature.

The second thermistor may further be provided against an abnormal operation of the first thermistor. As a result, the interior construction of the fuser is complicated, and material costs are increased.

Since a contact type temperature sensor has a slower response time to a temperature change than a non-contact type temperature sensor, a protection function may not be quickly performed at the time of initial booting or at a wakeup section of a power-saving mode, at which a temperature is abruptly increased within a short period of time.

### SUMMARY OF THE INVENTION

The present general inventive concept provides a fuser protection device having a protection circuit to protect a fuser by forcibly turning off a heater lamp when the heater lamp is overheated using a sensing signal from a non-contact thermistor to sense surface temperature of a heating roller and an image forming apparatus having the same.

Additional features and utilities of the present general inventive concept will be set forth in part in the description which follows and, in part, will be obvious from the description, or may be learned by practice of the general inventive concept

The foregoing and/or other features and utilities of the present general inventive concept may be achieved by providing a protection device usable with a fuser including a heating roller having a heater lamp and a pressing roller, the protection device including a temperature sensing unit to sense temperatures of the heating roller in a non-contact fashion using two sensors provided at different positions, a differential amplifier to amplify a voltage difference between two sensor outputs from the temperature sensing unit, and a comparator to compare the output voltage from the differential amplifier with a reference voltage, wherein a power supply to the heater lamp is blocked according to an output signal from the comparator.

The differential amplifier may amplify the voltage difference between an output signal from a first sensor provided outside a casing and directly exposed to heat from the heating roller and an output signal from a second sensor provided inside the casing and disposed away from the heating roller by a more distance than the first sensor.

The power supply to the heater lamp may be blocked by a drive unit to drive the heater lamp according to the output signal from the comparator.

A relay unit provided on a power line between the heater lamp and a power supply unit may be opened according to the output signal from the comparator to block the supply of power to the heater lamp.

The protection device may further include buffers to stabilize the two sensor outputs from the temperature sensing unit, which are input to the differential amplifier.

The foregoing and/or other features and utilities of the present general inventive concept may also be achieved by providing a protection device usable with a fuser including a heating roller having a heater lamp and a pressing roller, the protection device including a temperature sensing unit to sense one or more temperatures of the heating roller in a non-contact fashion using two sensors provided at different positions, a differential amplifier to amplify a voltage difference between two sensor outputs from the temperature sensing unit, a first comparator to compare the output voltage from the differential amplifier with a first reference voltage, and a second comparator to compare the output voltage from the differential amplifier with a second reference voltage, wherein power supply to the heater lamp is blocked by a drive unit to drive the heater lamp according to the output signal from the first comparator, and a relay unit provided to short-circuit a power line between the heater lamp and a power supply unit is opened according to the output signal from the second comparator to block the power supply to the heater lamp.

The differential amplifier may amplify the voltage difference between an output signal from a first sensor provided outside a casing and exposed to heat from the heating roller and an output signal from a second sensor provided inside the casing and disposed away from the heating roller by a more distance than the first sensor.

The first reference voltage of the first comparator may be lower than the second reference voltage of the second comparator.

The foregoing and/or other features and utilities of the present general inventive concept may also be achieved by providing an image forming apparatus which may include a photoconductor, an optical scanning device to form an electrostatic latent image on the photoconductor, a developing device to change the electrostatic latent image formed on the photoconductor into a toner image, a transfer belt to convey and transfer the toner image on the photoconductor to print media, a fuser comprising a heating roller having a heater lamp to fuse the toner image transferred to the transfer belt to the print media and a pressing roller, a temperature sensing unit to sense one or more temperatures of the heating roller in a non-contact fashion using two sensors provided at different positions, and a fuser protection unit to amplify a voltage difference between two sensor outputs from the temperature sensing unit, to compare the amplified output voltage with a reference voltage, and to block power supply to the heater lamp according to a comparison result.

The fuser protection unit may include a differential amplifier to amplify the voltage difference between the two sensor outputs from the temperature sensing unit and a comparator to compare the output voltage from the differential amplifier with the reference voltage and to output a drive signal to block the power supply to the heater lamp when the output voltage from the differential amplifier exceeds the reference voltage.

The differential amplifier may amplify the voltage difference between an output signal from a first sensor provided outside a casing to be directly exposed to heat from the heating roller and an output signal from a second sensor provided inside the casing to be disposed away from the heating roller by a more distance than the first sensor.

The image forming apparatus may further include a power supply unit to supply power to the heater lamp and a drive unit to switch power supplied to the heater lamp to drive the heater lamp, wherein the comparator may output the drive signal to block the supply of power to the heater lamp to the drive unit.

The image forming apparatus may further include buffers to stabilize the two sensor outputs from the temperature sensing unit, which are input to the differential amplifier.

The image forming apparatus may further include a power supply unit to supply power to the heater lamp and a relay unit provided to short-circuit a power line between the power supply unit and the heater lamp, wherein the comparator may output the drive signal to block the supply of power to the heater lamp to the relay unit.

The foregoing and/or other features and utilities of the present general inventive concept may also be achieved by providing an image forming apparatus which may include a photoconductor, an optical scanning device to form an electrostatic latent image on the photoconductor, a developing device to change the electrostatic latent image formed on the photoconductor into a toner image, a transfer belt to convey and transfer the toner image on the photoconductor to print media, a fuser comprising a heating roller having a heater lamp to fuse the toner image transferred to the transfer belt to the print media and a pressing roller, a power supply unit to supply power to the heater lamp, a drive unit to switch power supplied to the heater lamp to drive the heater lamp, a relay unit provided to short-circuit a power line between the power supply unit and the heater lamp, a temperature sensing unit to sense one or more temperatures of the heating roller in a non-contact fashion using two sensors provided at different positions, and a fuser protection unit to amplify voltage difference between two sensor outputs from the temperature sensing unit, to compare the amplified output voltage with two different reference voltages, and to drive the drive unit and/or the relay unit to block power supply to the heater lamp according to the comparison results.

The fuser protection unit may include a differential amplifier to amplify the voltage difference between the two sensor outputs from the temperature sensing unit, a first comparator to compare the output voltage from the differential amplifier with first reference voltage and to output a drive signal to block the power supply to the heater lamp to the drive unit when the output voltage from the differential amplifier exceeds the first reference voltage, and a second comparator to compare the output voltage from the differential amplifier with second reference voltage and to output a drive signal to block the power supply to the heater lamp to the relay unit when the output voltage from the differential amplifier exceeds the second reference voltage.

The first reference voltage of the first comparator may be lower than the second reference voltage of the second comparator.

The image forming apparatus may further include buffers to stabilize the two sensor outputs from the temperature sensing unit, which are input to the differential amplifier.

The foregoing and/or other features and utilities of the present general inventive concept may also be achieved by providing a protection device usable with a fuser having a heating roller having a heater lamp and a pressing roller in an image forming apparatus, the protection device including a temperature sensing unit having at least two non-contact sensors disposed at different position from the heating roller to sense at least two temperatures, and a control unit to control the heating roller according to the sensed at least two temperatures of the at least two non-contact sensors.

The control unit may include a comparator to compare a voltage difference of the at least two temperatures with a reference voltage, and the control unit may block the power supply to the heater lamp according to an output signal from the comparator.

The control unit may include a differential amplifier to amplify the voltage difference to output the amplified voltage to the comparator.

The control unit may generate one or more control signals, and the control unit may include an electrical switch and a mechanical switch each to prevent the power supply to the heater lamp according to the corresponding control signals.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating an image forming apparatus according to an embodiment of the present general inventive concept;

FIG. 2 is a view illustrating a fuser of an image forming apparatus according to an embodiment of the present general inventive concept;

FIG. 3 is a control block diagram illustrating an apparatus to control a temperature of a fuser of an image forming apparatus according to an embodiment of the present general inventive concept;

FIG. 4 is a circuit diagram illustrating a fuser protection unit of an image forming apparatus according to an embodiment of the present general inventive concept;

FIG. 5 is a circuit diagram illustrating a fuser protection unit of an image forming apparatus according to an embodiment of the present general inventive concept;

FIG. 6 is a view illustrating a fuser protection unit having a relay unit to disconnect a power line to a heater lamp in an image forming apparatus according to an embodiment of the present general inventive concept; and

FIG. 7 is a circuit diagram illustrating a fuser protection unit usable with an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

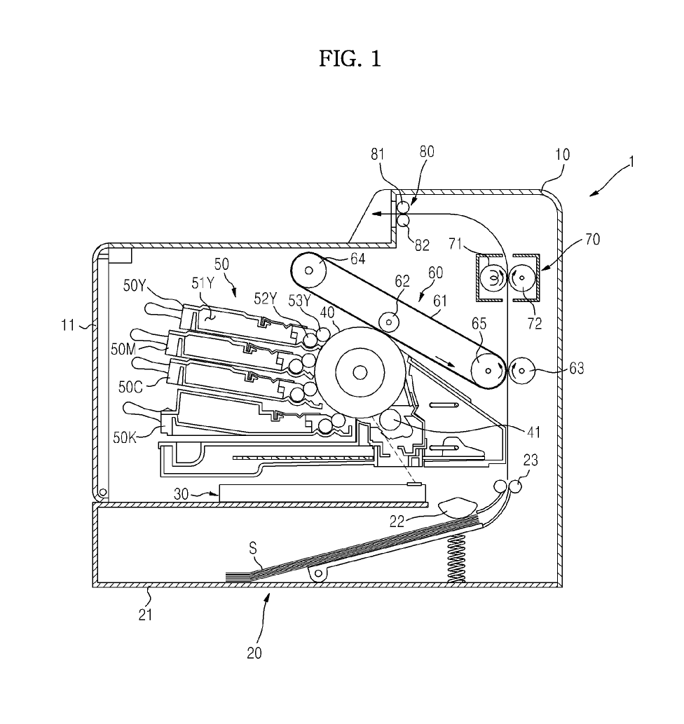

FIG. 1 is a view illustrating an image forming apparatus 1 according to an embodiment of the present general inventive concept.

As illustrated in FIG. 1, the image forming apparatus 1 includes a main body 10, a print media supply device 20, an optical scanning device 30, a photoconductor 40, a developing device 50, a transfer device 60, a fuser 70, and a print media discharging device 80.

The main body 10 forms the external appearance of the image forming apparatus 1 and supports various components installed therein. A main body cover 11 is rotatably installed at one side of the main body 10. The main body cover 11 opens and closes a portion of the main body 10.

The print media supply device 20 supplies print media S to the transfer device 60. The print media supply device 20 includes a cassette 21 to store print media S, a pickup roller 22 to pick up the print media S stored in the cassette 22 one by one, and a feeding roller 23 to feed the picked-up print media S to the transfer device 60.

The optical scanning device 30 is disposed under the developing device 50 to scan light corresponding image information to the photoconductor 40 so that an electrostatic latent image is formed on the surface of the photoconductor 40.

The photoconductor 40 has an optically conductive layer formed at the outer circumference of a cylindrical metal drum. The photoconductor 40 is an image carrier to carry an electrostatic latent image formed by the optical scanning device 30 and a toner image formed by the developing device 50. The photoconductor 40 is rotatably installed in the main body 10.

A charge roller 41 is installed in the main body 10. The charge roller 41 charges the photoconductor 40 with predetermined potential before scanning of light from the optical scanning device 30. The charge roller 41 is an example of an electrifier to charge the photoconductor 40 with uniform potential. The charge roller 41 supplies electric charges to the outer circumference of the photoconductor 40 while rotating in contact or non-contact with the outer circumference of the photoconductor 40 to charge the outer circumference of the photoconductor 40 with uniform potential. In addition to the charge roller 41, a corona discharger may be adopted as the electrifier.

The developing device 50 supplies toner (or developer) to the photoconductor 40, on which the electrostatic latent image is formed, to form a toner image (or developer image). The developing device 50 includes four developers 50Y, 50M, 50C, and 50K to store different color toners, e.g. yellow (Y), magenta (M), cyan (C), and black (K) toners, respectively.

The developers 50Y, 50M, 50C, and 50K include toner storage chambers 51Y, 51M, 51C, and 51K, supply rollers 52Y, 52M, 52C, and 52K, and developing rollers 53Y, 53M, 53C, and 53K, respectively.

The supply rollers 52Y, 52M, 52C, and 52K supply toner stored in the toner storage chambers 51Y, 51M, 51C, and 51K to the developing rollers 53Y, 53M, 53C, and 53K, respectively. Supply bias voltage to supply toner stored in the toner storage chambers 51Y, 51M, 51C, and 51K to the developing rollers 53Y, 53M, 53C, and 53K is applied to the supply rollers 52Y, 52M, 52C, and 52K. Although references 51M, 51C, 51K, 52M, 52C, 52K, 53M, 53C, and 53K are described here, these references are not illustrated in FIG. 1. However, there references indicate the developers, toner storage chambers, and developing rollers, respectively, in the same manner of the developer 51Y, the toner storage chamber 52Y, and the developing roller 53Y.

The developing rollers 53Y, 53M, 53C, and 53K stick toner on the surface of the photoconductor 40, on which the electrostatic latent image is formed, to form a toner image. Development bias voltage to develop toner supplied from the supply rollers 52Y, 52M, 52C, and 52K to the electrostatic latent image on the photoconductor 40 is applied to the developing rollers 53Y, 53M, 53C, and 53K.

The transfer device 60 includes an intermediate transfer belt 61, a first transfer roller 62, and a second transfer roller 63.

The intermediate transfer belt 61 is an image carrier to carry a toner image formed by the developing device 50. The intermediate transfer belt 61 is supported by support rollers 64 and 65 and runs at the same velocity as linear velocity of the photoconductor 40. A length of the intermediate transfer belt 61 is equal to or greater than that of the print media S having a maximum size used in the image forming apparatus.

The first transfer roller 62 faces the photoconductor 40 via the intermediate transfer belt 61 to transfer the toner image formed on the photoconductor 40 to the intermediate transfer belt 61. First transfer bias voltage to transfer the toner image formed on the photoconductor 40 to the intermediate transfer belt 61 is applied to the first transfer roller 62.

The second transfer roller 63 disposed to face the support roller 65 via the intermediate transfer belt 61. While the toner image from the photoconductor 40 is transferred to the intermediate transfer belt 61, the second transfer roller 63 is spaced apart from the intermediate transfer belt 61. When the toner image from the photoconductor 40 is completely transferred to the intermediate transfer belt 61, the second transfer roller 63 contacts the intermediate transfer belt 61 under predetermined pressure. When the second transfer roller 63 contacts the intermediate transfer belt 61, the toner image from the intermediate transfer belt 61 is transferred to print media. Second transfer bias voltage to transfer the toner image to the print media S is applied to the second transfer roller 63.

The fuser 70 serves to fuse the toner image to the print media S and to convey the print media, to which the toner image is fused, to the print media discharging device 80. The fuser 70 includes a heating roller 71 having a heat source and a pressing roller 72 disposed opposite to the heating roller 71 with respect to a passage of the print media S. When the print media S pass between the heating roller 71 and the pressing roller 72, the toner image is fused to the print media by heat from the heating roller 71 and pressure between the heating roller 71 and the pressing roller 72.

Meanwhile, the print media discharging device 80, including a discharging roller 81 and a discharging backup roller 82, discharges the print media S, having passed through the fuser 70, from the main body 10.

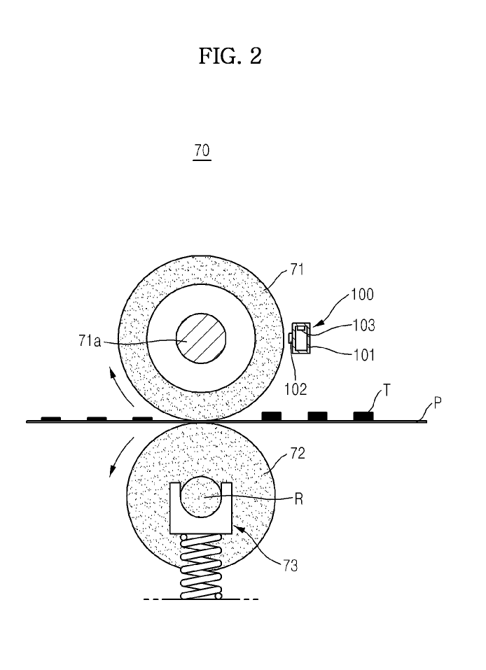

FIG. 2 is a view illustrating the fuser 70 of the image forming apparatus 1 of FIG. 1 according to an embodiment of the present general inventive concept.

As illustrated in FIGS. 1 and 2, the fuser 70 includes a heating roller 71, a pressing roller 72, and a pressing unit 73.

The heating roller 71 is rotatably installed to apply heat to the toner image T transferred to the print media P and to stick the toner image on the print media P. The heat generated from the heating roller 71 may change a state of the toner image T to be suitable to be fixed to the print media P. For example, the heat may molt the toner image T. The heating roller 71 includes a heater lamp 71a, such as a halogen lamp, in the center thereof as a heat source. The heater lamp 71a generates heat in the heating roller 71, and the heating roller 71 is heated by radiation from the heater lamp 71a.

The pressing roller 72 is positioned under the heating roller 71 via the print media P so that the pressing roller 72 is disposed opposite to the heating roller 71 with respect to the print media P. The pressing roller 72 is elastically supported by the pressing unit 73 so that the print media P passing between the heating roller 71 and the pressing roller 72 come into tight contact with the heating roller 71 under a predetermined pressure. When the print media P passes between the heating roller 71 and the pressing roller 72, heat and pressure are applied to the print media P, to which the toner image T has been transferred, so that the toner image T is melted and stuck on the surface of the print media P.

The pressing unit 73 support a shaft R of the pressing roller 72 so that the pressing roller 72 presses the print media P to generate a pressing force.

A temperature sensing unit 100 is provided in the vicinity of the heating roller 71.

The temperature sensing unit 100 senses a surface temperature of the heating roller 71. For example, the temperature sensing unit 100 may be a non-contact thermistor to sense a surface temperature of the heating roller 71 in a non-contact fashion. For reference, as illustrated in FIG. 2, the fuser 70 does not include a contact thermistor.

The temperature sensing unit 100 includes two non-contact temperature sensors 102 and 103 provided at a casing 101. The first sensor (hereinafter, TD sensor) 102 is provided at a first position outside or on an external portion of the casing 101 so as to be directly exposed to the heating roller 71, and the second sensor (hereinafter, TC sensor) 103 is provided at a second position inside or an inside portion of the casing 101.

The TD sensor 102 outputs a first output TD_OUT, which is a temperature signal value sensed at the first position. The first output TD_OUT indicates a surface temperature of the heating roller 71.

The TC sensor 103 outputs a second output TC_OUT, which is a temperature signal value sensed at the second position. The second output TC_OUT is a temperature signal value to compensate for the first output TD_OUT so that the first output TD_OUT indicates the surface temperature of the heating roller 71.

The sensor outputs TD_OUT and TC_OUT from the two sensors 102 and 103 of the temperature sensing unit 100 are transmitted to a controller to control an overall operation of the image forming apparatus 1. The controller controls power supplied to the heater lamp 71a based on the sensor outputs (TD output and TC output) to maintain the surface temperature of the heating roller 71 within a given temperature range and a safe temperature range.

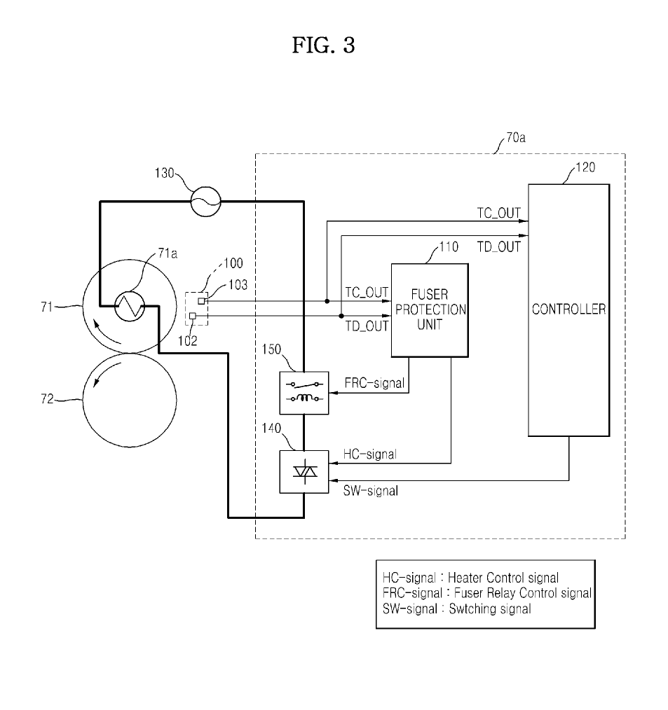

FIG. 3 is a control block diagram illustrating an apparatus to control of the temperature of the fuser 70 of the image forming apparatus 1 of FIG. 1 according to an embodiment of the present general inventive concept.

As illustrated in FIGS. 1 and 3, the image forming apparatus 1 includes a fuser protection unit 110, a controller 120, a power supply unit 130, a drive unit 140, and a relay unit 150. The fuser protection unit 110, the controller 120, the drive unit 140, and the relay unit 150 may be referred to as a control unit 70a to perform a fuser protecting operation according to temperatures detected by the temperature sensing unit 100.

As illustrated FIG. 3, the fuser 70 does not include a contact thermistor for protection, and the fuser protection unit 110 receives sensor outputs from the temperature sensing unit 100 having the non-contact thermistor to perform a protection function of the image forming apparatus 1.

The fuser protection unit 110 receives two sensor outputs TD_OUT and TC_OUT from the temperature sensing unit 100. The TD sensor 102 for temperature detection is directly exposed to the heating roller 71 to detect a temperature of the heating roller 71, and the TC sensor 103 is not directly exposed to the heating roller 71 but disposed inside the casing 101 to sense a temperature to be used to compensate for the temperature sensed by the TD sensor 102. At least a portion of the casing 101 is disposed between the TC sensor 103 and the heating roller 71 to prevent the TC sensor 103 from being directly exposed to the heating roller 71. When the temperature increases, a larger amount of heat is transmitted to the TD sensor 102, which is directly exposed to the heating roller 71, than to the TC sensor 103, which is disposed inside the casing 101, and thus the temperature of the TD sensor 102 becomes higher than that of the TC sensor 103.

A temperature difference between the TD output TD_OUT and the TC output TC_OUT due to the positions of the sensors increases as the temperature increases. The temperature difference may be linearly or uniformly increased according to the increase of the temperatures. The commercially available non-contact thermistors show such output characteristics of the non-contact thermistors constituting the temperature sensing unit 100.

The fuser protection unit 110 prevents the heater lamp 71a from being overheated using a characteristic thereof in which a ratio of the TD output TD_OUT to the TC output TC_OUT (TD_OUT/TC_OUT) is linearly increased due to the temperature increase of the non-contact thermistors, thereby protecting the fuser 70 from overheating.

The fuser protection unit 110 may output two control signals by stages according to the temperature increase so as to protect the fuser 70 from overheating. However, the present inventive concept is not limited thereto. It is possible that the fuser protection unit 110 may output only one control signal according to the temperature increase to prevent the fuser 70 from being overheating.

A first control signal HC-signal is a signal output to the drive unit 140. The first control signal HC-signal is a control signal to control the drive unit to block the supply of power to the heater lamp 71a and thus turn off the heater lamp 71a. When the supply of power to the heater lamp 71a is blocked by the drive unit 140, the surface temperature of the heating roller 71 is gradually lowered.

A second control signal FRC-signal is a signal directly output to the relay unit 150. The second control signal FRC-signal is a control signal to directly open the relay unit 150. When the relay unit 150 is turned off, the power line to the heater lamp 71a is physically short circuited.

In the same manner as the fuser protection unit 110, the controller 120 receives two sensor outputs TD_OUT and TC_OUT from the temperature sensing unit 100. The controller 120 converts analog values of the sensor outputs TD_OUT and TC_OUT into digital values and compares a combination of sensor outputs TD_OUT and TC_OUT with a predetermined temperature table to recognize the temperature of the heating roller 71.

Also, the controller 120 outputs a control signal SW-signal for on and off control of the heater lamp 71 to the drive unit 140 so that the temperature of the heating roller 71 is maintained within a predetermined temperature range.

The power supply unit 130 supplies power to the fuser 70.

The drive unit 140 switches power supplied to the heater lamp 71a according to a control signal from the controller 120 to supply power from the power supply unit 130 to the heater lamp 71a or to block the power supply from the power supply unit 130 to the heater lamp 71a. When the drive unit 140 receives the first control signal HC-signal from the fuser protection unit 110 while the drive unit 140 supply power from the power supply unit 130 to the heater lamp 71a according to the control signal SW-signal from the controller 120, the drive unit 140 turns off a switching element (for example, a TRIAC) to block the supply of power to the heater lamp 71a. As a result, the temperature of the heater lamp 71a is gradually lowered.

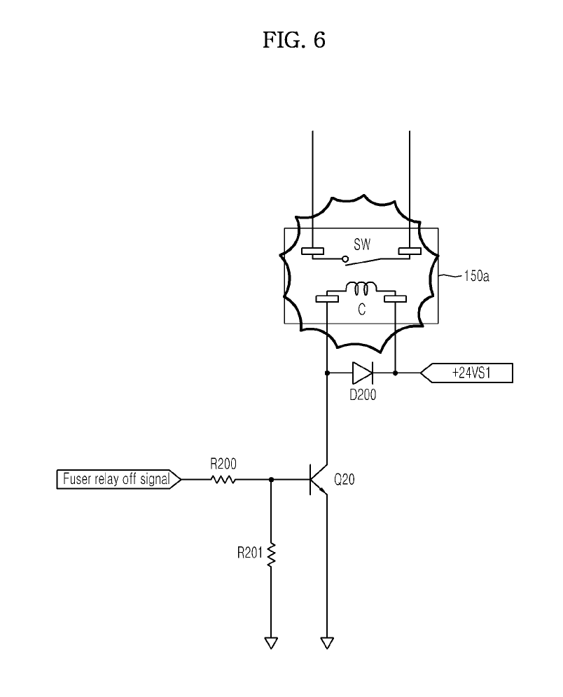

The relay unit 150 includes a relay 150a having a relay coil C and a relay switch SW as illustrated in FIG. 6. The relay unit 150 is provided on a power line between the power supply unit 130 and the drive unit 140. The relay unit 150 is driven according to the second control signal FRC-signal received from the fuser protection unit 110 to physically open the power line to the heater lamp 71. As the power line is physically opened, the power supply to the heater lamp 71 is more securely blocked when the drive unit 140 fails to block the power supply to the heater lamp 71a. The relay unit 150 may include resistors R200 and R201, a transistor Q20, and a diode D200.

The drive unit 140 may electrically disconnect an electrical line for the power supply, and the relay unit 150 may mechanically disconnect the electrical line for the power supply.

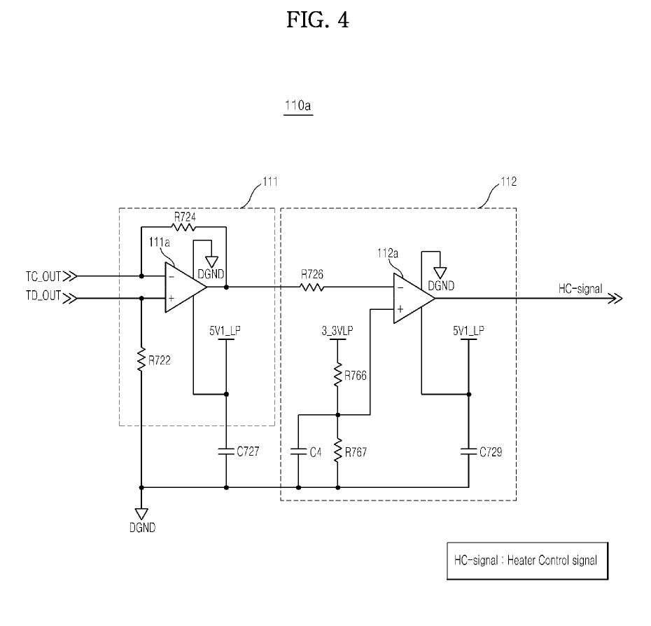

FIG. 4 is a circuit diagram illustrating a fuser protection unit 110a of an image forming apparatus according to an embodiment of the present general inventive concept. The fuser protection unit 110a may correspond to the fuser protection unit 110 of FIG. 3.

As illustrated in FIGS. 1-4, the fuser protection unit 110a includes an amplification circuit 111 and a comparison circuit 112.

The amplification circuit 111 includes a differential amplifier (OPAMP) 111a.

The comparison circuit 112 includes a comparator 112a.

The fuser protection unit 110a includes the differential amplifier 111a and the comparator 112a using the two sensor outputs TD_OUT and TC_OUT from the temperature sensing unit to perform a protection function of image forming apparatus 1.

The amplification circuit 111 may include resistors R722 and R724 and a capacitor C727. The comparator 112 may include resistors R726, R766, ad R767 and capacitors C4 and C729.

The circuit using the differential amplifier 111a and the comparator 112a performs a protection function of the fuser 70 in the same manner as the conventional contact thermistor. That is, when malfunction occurs, e.g. the fuser 70 is abnormally overheated, a first control signal HC-signal, which is a heater off signal, is output to the drive unit 140 so that the drive unit 140 automatically blocks the supply of power to the heater lamp 71a.

Referring back to FIG. 4, the two sensor outputs TD_OUT and TC_OUT from the temperature sensing unit 100 are input to the differential amplifier 111a. Upon receiving the sensor outputs TD_OUT and TC_OUT, the differential amplifier 111a amplifies and outputs the difference between the TC output TC_OUT and the TD output TD_OUT. At this time, the differential amplifier 111a processes the output signal level into a signal level to be processed by the comparator 112a.

The output differentially amplified by the differential amplifier 111a has a tendency to be gradually increased as the temperature of the heating roller 71 sensed by the TD sensor 102, which is directly exposed to heat, is increased. The difference between the TD output TD_OUT and the TC output TC_OUT due to the position difference between the TD sensor 102 and the TC sensor 103 increases as the temperature increases. The amplified output from the differential amplifier 111a is input to the comparator 112a, which performs a protection function.

When the output from the differential amplifier 111a is input to a reverse terminal, i.e. a minus (negative) terminal, of the comparator 112a, the comparator 112a compares the input signal value with a reference value of a non-reverse terminal, i.e. a plus (positive) terminal. When the input to the reverse terminal is equal to or less than the reference value of the plus terminal, the comparator 112a outputs a first control signal HC-signal of a low level. When the input to the reverse terminal is greater than the reference value of the plus terminal, the comparator 112a outputs a first control signal HC-signal of a high level. The first control signal HC-signal of the voltage level is output to the drive unit 140. In a normal state in which a voltage value of a specific temperature band (range) is set as a reference value of the comparator 112a, and the comparator 112a is controlled within a usable temperature band, the comparator 112a outputs a first control signal HC-signal of a low level to the drive unit 140. On the other hand, in an abnormal state, the comparator 112a outputs a first control signal HC-signal of a high level to the drive unit 140 so that the drive unit 140 blocks the supply of power to the heater lamp 71a.

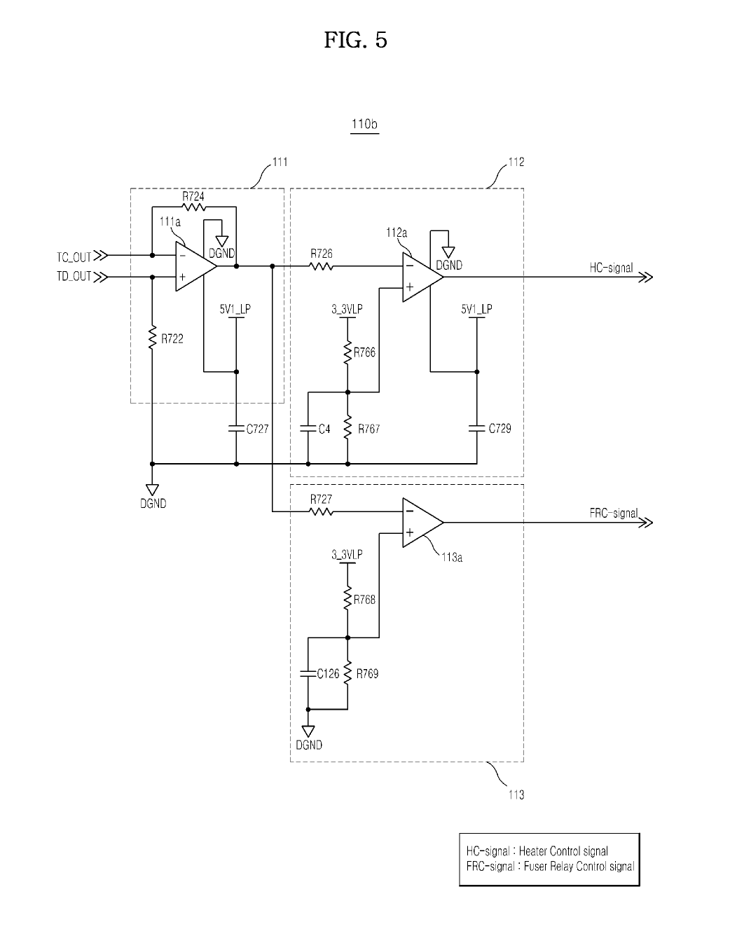

FIG. 5 is a circuit diagram illustrating a fuser protection unit 110b of an image forming apparatus according to an embodiment of the present general inventive concept. The fuser protection unit 110b may correspond to the fuser protection unit 110 of FIG. 3 and the fuser protection unit 110a of FIG. 4.

As illustrated in FIGS. 1-5, the fuser protection unit 110b may include one amplification circuit 111 and two comparison circuits 112 and 113.

That is, the fuser protection unit 110b may include a plurality of comparison circuits to perform a more precise fuser protection function.

The fuser protection unit 110b may include the amplification circuit 111 having a differential amplifier 111a and the first comparison circuit 112 having a first comparator 112a in the same manner as the fuser protection unit 110 of FIG. 4. When the fuser 70 is overheated, the fuser protection unit 110, including the differential amplifier 111a and the first comparator 112a, outputs a heater control signal HC-signal (for example, a first control signal of a high level), which is a heater off signal, to the drive unit 140 so that the drive unit 140 automatically blocks the supply of power to the heater lamp 71a.

The amplification circuit 111 may include resistors R722 and R724 and a capacitor C727. The first comparator 112 may include resistors R726, R766, ad R767 and capacitors C4 and C729. The second comparison circuit 113 may include resistors R727, R768, and 769 and a capacitor C126.

Meanwhile, the second comparison circuit 113 includes a second comparator 113a. When blocking the power supply to the heater lamp 71a according to the heater control signal HC-signal of the first comparator 112a fails, the fuser protection unit 110, including the differential amplifier (OPAMP) 111a and the second comparator 113a, outputs a fuser relay control signal FRC-signal, which is a fuser relay off signal, to the drive unit 140 such that a power line to the heater lamp 71a is physically (mechanically) blocked by opening of the relay unit 150.

As described above, the fuser protection unit 110b including the comparison circuits 112 and 113 performs a protection operation by the following two stages. First, when the sensed temperature exceeds a predetermined temperature, a heater off signal is output to the drive unit 140 through the first comparator 112a. The heater off signal temporarily turns off a heater control signal input to the switching element of the drive unit 140. When the temperature is not lowered according to the heater off signal but continues to be increased, a fuser relay off signal FRC-signal is output to the relay unit 150 for system protection. The second comparison circuit 113 may compare the continuously increased temperature with a second predetermined temperature which is different from the predetermined temperature of the first comparison circuit 112. The fuser relay off signal FRC-signal blocks the supply of power to the drive unit 140. The fuser relay off signal FRC-signal is a more secure protection signal than the heater off signal. When the fuser relay off signal FRC-signal is input, the relay unit 150, which supplies power to the fuser 70, is opened, and therefore the supply of power to the heater lamp 71a is blocked. As a result, power is not physically supplied to the heater lamp 71a, and therefore, the temperature of the heating roller 71 is gradually lowered.

As described above, the first-stage protection function to output the heater control signal HC-signal to the drive unit 140 when the heating roller 71 is overheated forcibly turns off the switching element, i.e. the TRIAC, of the drive unit 140 so that the drive unit 140 blocks the supply of power to the heater lamp 71a. When the temperature of the heating roller 71 is not lowered through the first-stage protection function but continues to be increased, a second-stage protection function is operated. The second-stage protection function to output a fuser relay control signal FRC-signal to the relay unit 150 opens the relay unit 150 so that power is not physically supplied to the heater lamp 71a. The fuser 70 is protected from overheating through the above two stage protection functions.

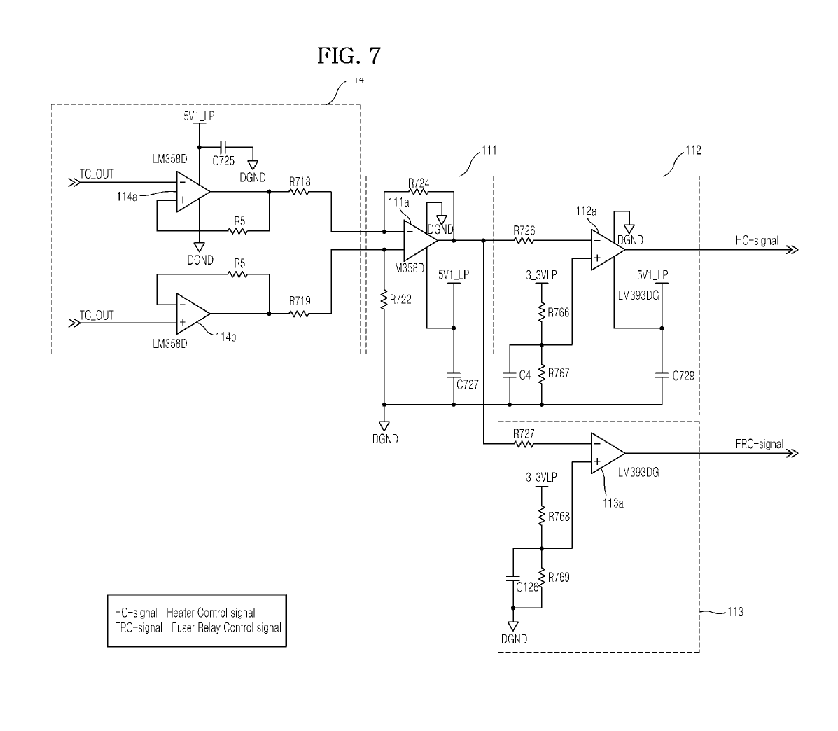

FIG. 7 is a circuit diagram illustrating a fuser protection unit 110c of an image forming apparatus according to an embodiment of the present general inventive concept. The fuser protection unit 110c may correspond to the fuser protection unit 110 of FIG. 3 and the fuser protection unit 110b of FIG. 5.

As illustrated in FIGS. 1-5 and 7, the fuser protection unit 110c may include a buffer circuit 114 having buffers 114a and 114b disposed at the front stage of the differential amplifier 111a to stabilize a TC output TC_OUT and a TD output TD_OUT from the temperature sensing unit 100, which are input to the differential amplifier 111a. Before input to the differential amplifier 111a, the TC output TC_OUT and the TD output TD_OUT pass through the buffer circuit 114 so that the TC output TC_OUT and the TD output TD_OUT are stabilized. As described above, the buffers 114a and 114b are provided to stably maintain levels of the input signals, and therefore, more stable signals may be transmitted to the next stage.

The buffer circuit 114 may include resistors R5, R718, and R719 and a capacitor C725. And fuser protection unit 110c may have an amplification circuit 111 and first and second comparison circuits 112 and 113 which are similar to the amplification circuit 111 and the first and second comparison circuits 112 and 113 of FIG. 5.

For a general fuser, one heater lamp (hereinafter, main heater lamp) is provided in the center of a heating roller. In addition, the heating roller may be provided at an inner circumference thereof with a side heater lamp (auxiliary heater lamp). In this case, the main heater lamp heats a major portion of the fuser, and the auxiliary heater lamp heats a remaining portion of the fuser. Generally, the main heater lamp has a greater capacity than the auxiliary heater lamp.

In a case in which the fuser includes a plurality of heater lamps as described above, thermistors may be respectively necessary for the main heater lamp and the auxiliary heater lamp, and a protection circuit may be realized for each heater lamp. The protection circuit construction of the auxiliary heater lamp is identical to that of the main heater lamp except that set temperatures of protection signals differ depending upon a difference in piping construction and a capacity between the heater lamps. That is, the main heater lamp may have a higher capacity than the auxiliary heater lamp and may perform a paper fusing operation on a larger section than the auxiliary heater lamp, and therefore, a target temperature of the main heater lamp may be higher than that of the auxiliary heater lamp. Consequently, a reference voltage of the comparator controlled by the protection circuit may be set to a higher level.

In the above description, the fuser protection unit 110 primarily blocks the supply of power to the heater lamp 71a through the drive unit 140 when the heating roller 71 is overheated; however, embodiments of the present general inventive concept are not limited thereto. The relay unit 150, instead of the drive unit 140, may be opened to prevent overheating of the heating roller 71.

According to an embodiment of the present general inventive concept as described above, a protection function to protect the fuser when the heater lamp is overheated is realized based on a simple circuit construction using a sensing signal of the non-contact thermistor to sense a surface temperature of the heater roller, thereby reducing manufacturing costs.

Also, the present general inventive concept provides a simple circuit construction to protect a fuser using a sensor output of a non-contact thermistor, thereby reducing material costs of interface signal wires.

Also, the features and utilities of the present general inventive concept may prevent an abnormal situation at the initial heating stage, which is difficult to sense using a contact thermistor having a lower response to a temperature change than the non-contact thermistor.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A protection device usable with a fuser comprising a heating roller having a heater lamp and a pressing roller in an image forming apparatus, the protection device comprising:
a temperature sensing unit to sense one or more temperatures of the heating roller in a non-contact fashion using two sensors provided at different positions;
a differential amplifier to amplify a voltage difference between two sensor outputs from the temperature sensing unit; and
a comparator to compare an output voltage from the differential amplifier with a reference voltage,
wherein power supply to the heater lamp is blocked according to an output signal from the comparator.

2. The protection device of claim 1, wherein the differential amplifier amplifies the voltage difference between an output signal from a first sensor provided outside a casing and directly exposed to heat from the heating roller and an output signal from a second sensor provided inside the casing and disposed away from the heating roller by a more distance than the first sensor.

3. The protection device of claim 1, wherein the power supply to the heater lamp is blocked by a drive unit to drive the heater lamp according to the output signal from the comparator.

4. The protection device of claim 1, wherein a relay unit is provided on a power line between the heater lamp and a power supply unit to be opened according to the output signal from the comparator to block the power supply to the heater lamp.

5. The protection device of claim 1, further comprising:
one or more buffers to stabilize the two sensor outputs from the temperature sensing unit to output the stabilized outputs to the differential amplifier.

6. A protection device usable with a fuser comprising a heating roller having a heater lamp and a pressing roller in an image forming apparatus, the protection device comprising:
a temperature sensing unit to sense one or more temperatures of the heating roller in a non-contact fashion using two sensors provided at different positions;
a differential amplifier to amplify a voltage difference between two sensor outputs from the temperature sensing unit;
a first comparator to compare an output voltage from the differential amplifier with a first reference voltage; and
a second comparator to compare the output voltage from the differential amplifier with a second reference voltage,
wherein power supply to the heater lamp is blocked by a drive unit to drive the heater lamp according to the output signal from the first comparator, and a relay unit provided to short-circuit a power line between the heater lamp and a power supply unit is opened according to the output signal from the second comparator to block the power supply to the heater lamp.

7. The protection device of claim 6, wherein the differential amplifier amplifies the voltage difference between an output signal from a first sensor provided outside a casing and directly exposed to heat from the heating roller and an output signal from a second sensor provided inside the casing and disposed away from the heating roller by a more distance than the first sensor.

8. The protection device of claim 6, wherein the first reference voltage of the first comparator is lower than the second reference voltage of the second comparator.

9. An image forming apparatus comprising:
a photoconductor;
an optical scanning device to form an electrostatic latent image on the photoconductor;
a developing device to change the electrostatic latent image formed on the photoconductor into a toner image;
a transfer belt to convey and transfer the toner image on the photoconductor to print media;
a fuser comprising a heating roller having a heater lamp to fuse the toner image transferred to the transfer belt to the print media and a pressing roller;
a temperature sensing unit to sense one or more temperatures of the heating roller in a non-contact fashion using two sensors provided at different positions; and
a fuser protection unit to amplify a voltage difference between two sensor outputs from the temperature sensing unit, to compare the amplified output voltage with a reference voltage, and to block power supply to the heater lamp according to a comparison result.

10. The image forming apparatus of claim 9, wherein the fuser protection unit comprises:
a differential amplifier to amplify the voltage difference between the two sensor outputs from the temperature sensing unit; and
a comparator to compare the output voltage from the differential amplifier with the reference voltage and to output a drive signal to block the power supply to the heater lamp when the output voltage from the differential amplifier exceeds the reference voltage.

11. The image forming apparatus of claim 10, wherein the differential amplifier amplifies the voltage difference between an output signal from a first sensor provided outside a casing and directly exposed to heat from the heating roller and an output signal from a second sensor provided inside the casing and disposed away from the heating roller by a more distance than the first sensor.

12. The image forming apparatus of claim 10, further comprising:
a power supply unit to supply a power to the heater lamp; and
a drive unit to switch the power supplied to the heater lamp to drive the heater lamp,
wherein the comparator outputs the drive signal to block the power supply to the heater lamp to the drive unit.

13. The image forming apparatus of claim 10, further comprising:
one or more buffers to stabilize the two sensor outputs from the temperature sensing unit to output the stabilized sensor outputs to the differential amplifier.

14. The image forming apparatus according to claim 10, further comprising:
a power supply unit to supply power to the heater lamp; and
a relay unit provided to short-circuit a power line between the power supply unit and the heater lamp,
wherein the comparator outputs the drive signal to block the power supply to the heater lamp to the relay unit.

15. An image forming apparatus comprising:
a photoconductor;
an optical scanning device to form an electrostatic latent image on the photoconductor;
a developing device to change the electrostatic latent image formed on the photoconductor into a toner image;
a transfer belt to convey and transfer the toner image on the photoconductor to print media;
a fuser comprising a heating roller having a heater lamp to fuse the toner image transferred to the transfer belt to the print media and a pressing roller;
a power supply unit to supply a power to the heater lamp;
a drive unit to switch power supplied to the heater lamp to drive the heater lamp;
a relay unit provided to short-circuit a power line between the power supply unit and the heater lamp;
a temperature sensing unit to sense one or more temperatures of the heating roller in a non-contact fashion using two sensors provided at different positions; and
a fuser protection unit to amplify a voltage difference between two sensor outputs from the temperature sensing unit, to compare the amplified output voltage with two different reference voltages, and to drive the drive unit and/or the relay unit to block the power supply to the heater lamp according to comparison results.

16. The image forming apparatus of claim 15, wherein the fuser protection unit comprises:
a differential amplifier to amplify the voltage difference between the two sensor outputs from the temperature sensing unit;
a first comparator to compare the output voltage from the differential amplifier with a first reference voltage and to output a drive signal to block the power supply to the heater lamp to the drive unit when the output voltage from the differential amplifier exceeds the first reference voltage; and
a second comparator to compare the output voltage from the differential amplifier with a second reference voltage and to output a drive signal to block the power supply to the heater lamp to the relay unit when the output voltage from the differential amplifier exceeds the second reference voltage.

17. The image forming apparatus of claim 16, wherein the first reference voltage of the first comparator is lower than the second reference voltage of the second comparator.

18. The image forming apparatus of claim 16, further comprising:
one or more buffers to stabilize the two sensor outputs from the temperature sensing unit to output the stabilized sensor outputs to the differential amplifier.

19. A protection device usable with a fuser comprising a heating roller having a heater lamp and a pressing roller in an image forming apparatus, the protection device comprising:
a temperature sensing unit having at least two non-contact sensors disposed at different position from the heating roller to sense at least two temperatures; and
a control unit to control the heating roller according to the sensed at least two temperatures of the at least two non-contact sensors.

20. The protection device of claim 19, wherein:
the control unit comprises a comparator to compare a voltage difference of the at least two temperatures with a reference voltage; and
the control unit blocks the power supply to the heater lamp according to an output signal from the comparator.

21. The protection device of claim 20, wherein:
the control unit comprises a differential amplifier to amplify the voltage difference to output the amplified voltage to the comparator.

22. The protection device of claim 19, wherein:
the control unit generates one or more control signals; and
the control unit comprises an electrical switch and a mechanical switch each to prevent the power supply to the heater lamp according to the corresponding control signals.
